(19) United States
(12) Patent Application Publication
(10) Pub. No.: US 2020/0253219 A1
(43) Pub. Date: Aug. 13, 2020

(54) Turntable assembly of filling-wrapping food forming machine

(71) Applicant: SHANGHAI SOONTRUE MACHENERY EQUIPMENT CO., LTD., Shanghai (CN)

(72) Inventor: Song Huang, Shanghai (CN)

(21) Appl. No.: 16/647,031

(22) PCT Filed: Mar. 9, 2018
(86) PCT No.: PCT/CN2018/078534

§ 371 Date: Mar. 13, 2020

(30) Foreign Application Priority Data
Sep. 30, 2017 (CN) 201710913590.0

(51) Int. Cl. A21C 9/06

(52) U.S. Cl. CPC A21C 9/063

(57) ABSTRACT

A turntable assembly of a filling-wrapping food forming machine includes a turntable body, multiple forming molds evenly distributed on the turntable body, and an opening structure provided on the turntable body for wrapper scraps access to achieve recovery of wrapper scraps, wherein a distance from an inner side of each of the multiple forming molds to a center of the turntable body is larger than a distance from an inner side of the opening structure to the center of the turntable body. Through the opening structure, the present invention is able to achieve the recovery of wrapper scraps on the basis of the existing structure and make full use of the space under the turntable assembly. A recycling bin is placed or a wrapper scrap processing apparatus is installed under the opening structure, so that the wrapper scraps are directly stored or reused after being treated.

### CROSS REFERENCE OF RELATED APPLICATION

This is a U.S. National Stage under 35 U.S.C 371 of the International Application PCT/CN2018/078534, filed Mar. 9, 2018, which claims priority under 35 U.S.C. 119(a-d) to CN 201710913590.0, filed Sep. 30, 2017.

### BACKGROUND OF THE PRESENT INVENTION

### Field of Invention

The present invention relates to the field of food processing technology, and more particularly to a turntable assembly of a filling-wrapping food forming machine.

### Description of Related Arts

When the existing stuffed foods are processed, the volume of the equipment is usually large, and the occupied area of the dough cover processing device is particularly prominent. Therefore, how to miniaturize the filling-wrapping food forming machine has been a problem in the food processing field.

Existing patents such as CN 200820062031.X, which is filed on Jan. 29, 2008 and titled as “Dumpling Machine”, discloses a technical solution that a dumpling machine, includes a dough input device, a filling device, a dumpling forming device, a discharging tailstock and a driving device, wherein the dumpling forming device includes a horizontally-positioned station turntable and a forming mold on the surface of the station turntable; the dough input device and the filling device are respectively set the dough receiving station and the filling station of the turntable; a starting device is set at the contracting station, a pushing device is provided at one side of the pushing station, the discharging tailstock is provided at another side of the pushing station; under the control of the rail, the mold is unfolded, placed, contracted, opened and expanded at different stations under the control of the guide rail.

For another example, CN 201610274834.0, which is filed on Apr. 28, 2016 and titled as “Compact Filling-wrapping Food Forming Machine”, discloses that a technical solution that the present invention belongs to the field of food processing technology, and more particularly to a compact filling-wrapping food forming machine, which includes a frame and a station turntable on the frame, wherein a dough wrapper making device, a filling device, a pressing device and a discharging device are respectively located around the station turntable; the dough wrapper making device is located at the dough wrapping making station, the filling device is located at the filling station, the pressing device is located at the pressing station, the discharging device is located at the discharging station; a split-type forming mold which is located on the frame includes a rotary receiving plate and a mold cup which are independent from each other.

Regarding the above patents for achieve filling-wrapping, no matter which scheme is adopted, a convenient and space-saving solution for the processing of dough belts and the recovery of wrapper scraps after the peeling treatment is still not proposed, causing that the volume of the entire forming machine is unable to be further reduced. Moreover, the wrapper scrap recycling apparatus is complicated in structure, so the process control points of the whole machine are numerous, the failure rate is high, and the maintenance and use costs are high.

### SUMMARY OF THE PRESENT INVENTION

In order to overcome the problem that the volume of the filling-wrapping food forming machine is unable to be further reduced in the prior art, the present invention provides a turntable assembly of a filling-wrapping food forming machine, which is capable of effectively processing the dough belt and wrapper scraps of the filling-wrapping food forming machine.

To achieve the above technical effect, the present invention provides a technical solution as follows.

A turntable assembly of a filling-wrapping food forming machine comprises: a turntable body, multiple forming molds evenly distributed on the turntable body, and an opening structure provided on the turntable body for wrapper scraps access to achieve recovery of wrapper scraps, wherein a distance from an inner side of each of the multiple forming molds to a center of the turntable body is larger than a distance from an inner side of the opening structure to the center of the turntable body. Here, the opening structure is a through-hole structure which penetrates through the turntable body. When the distance from the inner side of each of the multiple forming molds to the center of the turntable body is larger than the distance from the inner side of the opening structure to the center of the turntable body, the wrapper scraps will more easily fall into the opening structure for recycling.

The opening structure is continuously set on the turntable body. The continuous setting means that the opening structure is not disconnected, and is a complete whole. Therefore, under the premise that the turntable body rotates, the continuous wrapper scraps are able to continuously fall into the opening structure. Only when the opening structure is continuously set, the wrapper scraps are able to be recovered during the rotation of the turntable assembly.

The opening structure is round and is provided in a middle of the turntable body.

The opening structure is annular and is provided in a middle of the turntable body or provided at a position outside the middle of the turntable body.

The opening structure penetrates through an upper surface and a lower surface of the turntable body.

The relative position of the forming molds to the opening structure is described as follows:

An upper surface of each of the forming molds is provided above an upper surface of the opening structure, and each of the forming molds is located outside the opening structure.

An upper surface of each of the forming molds is provided above an upper surface of the opening structure, and the projection of each of the forming molds in the vertical direction partially or completely falls within the opening structure.

Limitation on the shape of the turntable body is described as follows:

The turntable body is rectangular, circular or irregular.

A rotary sleeve is located below the turntable body and is connected with a wheel, the wheel is connected with a worm, and the worm is connected with a motor.

The working principle of the turntable assembly is described as below.

The motor drives the turntable body to rotate, so as to drive the forming molds which are connected with the turntable body to rotate together, the wrapper scraps after the peeling treatment enter the opening structure on the turntable body, thereby achieving the recovery of wrapper scraps. A base and a guide plate, both of which are located below the turntable body, maintain independence from the turntable body, so that the base and the guide plate stay still in the course of work. Moreover, guide rails are respectively provided on both the base and the guide plate, wrapper receiving plates and the mold cups are driven to move up and down via rollers on the forming molds under the action of the guide rails.

Beneficial effects of the turntable assembly provided by the present invention are as follows.

(1) Through the opening structure of the turntable assembly for wrapper scraps access after the peeling treatment, the present invention is able to achieve the recovery of wrapper scraps on the basis of the existing structure and make full use of the space under the turntable assembly. A recycling bin is placed or a wrapper scrap processing apparatus is installed under the opening structure, so that the wrapper scraps are directly stored or reused after being treated. In addition, the above structure does not increase the occupied space of the overall machine, and solves the problem that the overall machine is unable to be further miniaturized since extra space is required for the treatment of wrapper scraps. The present application is more conductive to the miniaturization and compactness of the whole machine, and is more suitable for homes, canteens, stores and so on.

(2) The opening structure of the present application has various shapes according to actual needs, as long as under the premise that the wrapper scraps are convenient to fall into the opening structure. Under the premise that the distance from the inner side of each of the forming molds to the center of the turntable body is larger than the distance from the inner side of the opening structure to the center of the turntable body, whether each of the forming molds is located outside the opening structure, or the projection of each of the forming molds in the vertical direction partially or completely falls within the opening structure, it is ensured that the wrapper scraps are able to easily enter the opening structure without installing additional wrapper scrap guiding device.

(3) The present invention adopts the motor to drive a transmission structure formed by the wheel and the worm, so as to drive the rotary sleeve and the turntable body to rotate, the independent driving structure ensures that there is no need to set a complicated cam transmission structure below the turntable body as in the prior art, avoiding the problem of a power source driving all components, so that a lot of space are saved for the storage or follow-up treatment of wrapper scraps.

The structure of the rails is described as below.

A base is located below the turntable body, a guide plate located between the base and the turntable body has a cylindrical shape as a whole. A first guide rail, provided at an outer side of the cylindrical guide plate, respectively cooperates with first rollers through the wrapper receiving plates of the forming molds, so as to realize the lifting movement of the wrapper receiving plates at different levels.

The guide plate is a continuous cylinder.

The cylindrical guide plate has a disconnection portion, and the disconnection portion is partially disconnected or completely disconnected, which means that the guide plate is provided only at a position where the components of the forming molds need to be adjusted up and down, and the guide plate is omitted at a position that does not need to change the height.

There is at least one disconnection portion.

A second guide rail, provided at an outer edge of the base, respectively cooperates with second rollers through mold cups of the forming molds, so as to realize the lifting movement of the mold cups at different levels.

The working principle of the rails is described as follows.

Specifically, the structure of the forming molds is the prior art. Each of the forming molds comprises a wrapper receiving plate and a mold cup located within the wrapper receiving plate. The first rollers are respectively connected with a bottom of the wrapper receiving plates through a connecting rod. The second rollers are respectively connected with a bottom of the mold cups through another connecting rod. Since the forming molds rotate with the turntable body, and the guide plate and the base remain stationary, the wrapper receiving plates, driven by the first rollers, move up and down along the wavy path of the first guide rail which is provided at the outer side of the guide plate. The mold cups also move up and down at different levels with the cooperation of the second guide rail and the second rollers. As a result, the lifting action of the forming molds at different stations and different parts is realized.

Beneficial effects of the rails are described as follows.

The guide plate and the base cooperate with each other to respectively control the lifting movement of the wrapper receiving plates and the mold cups of the forming mold at different positions. Both the first guide rail on the guide plate and the second guide rail on the base are able to be set as a discontinuous structure, that is, the first guide rail and the second guide rail are set only at a position where the corresponding structural height needs to be adjusted, there is no need to continuously set the rails, which saves materials and simplifies the structure.

### BRIEF DESCRIPTION OF THE DRAWINGS

FIG. 1 is an overall structurally schematic view of a turntable assembly.

FIG. 2 is a sectional view of the turntable assembly.

FIG. 3 is a structurally schematic view of a guide plate and a first guide rail.

FIG. 4 is a structurally schematic view of a second guide rail on a base.

FIG. 5 shows a distance D from an inner side of a forming mold to a center of a turntable body is larger than a distance d from an inner side of an opening structure to the center of the turntable body.

FIG. 6 is a structurally schematic view of an annular opening structure.

FIG. 7 shows forming molds are located outside the opening structure.

FIG. 8 shows the projections of the forming molds in the vertical direction partially or completely fall within the opening structure.

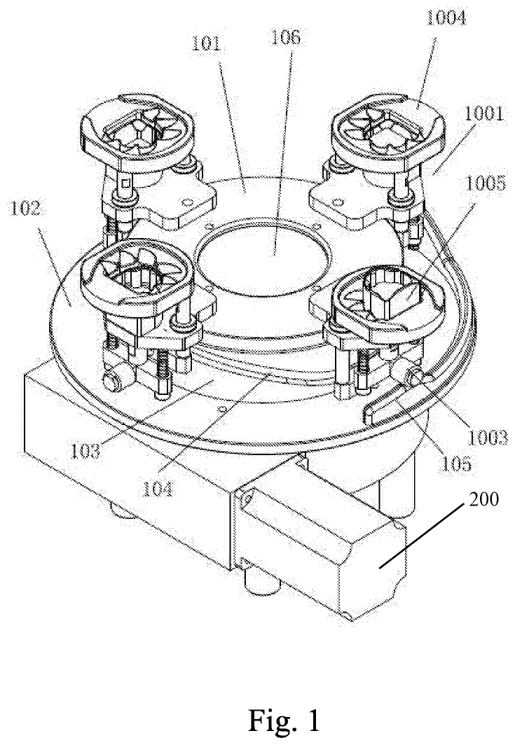

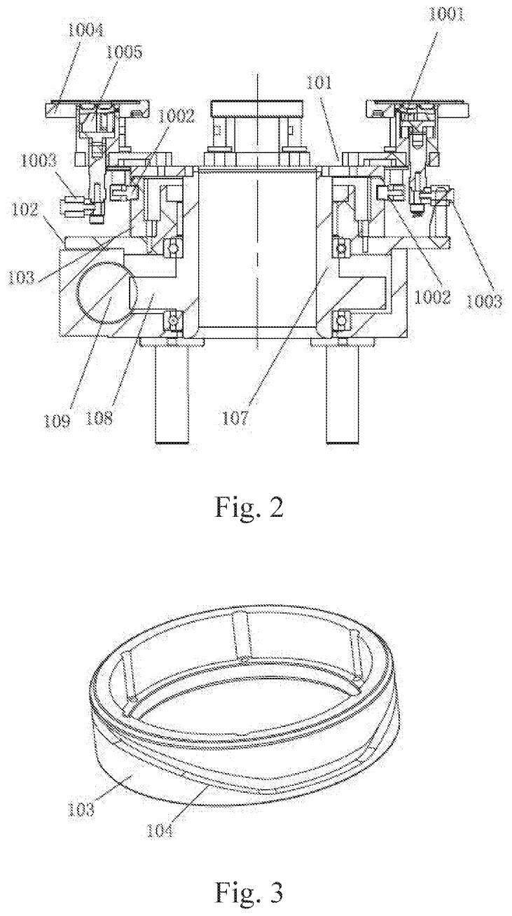

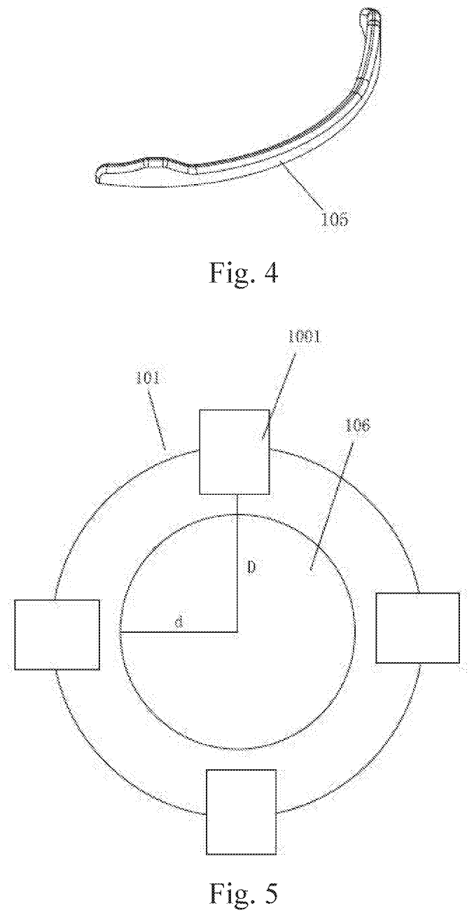

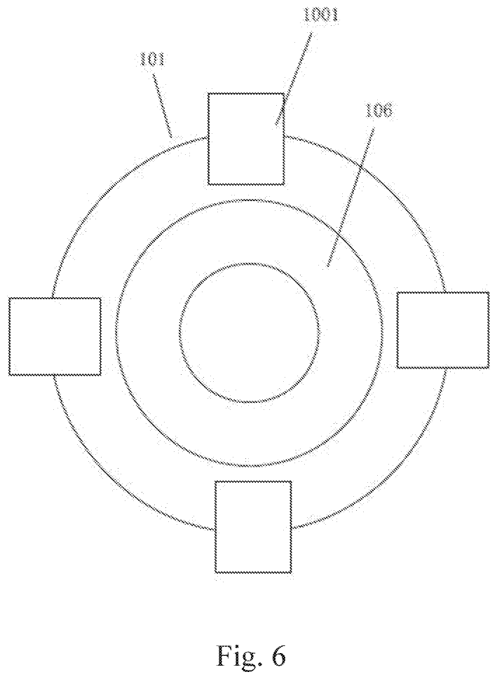

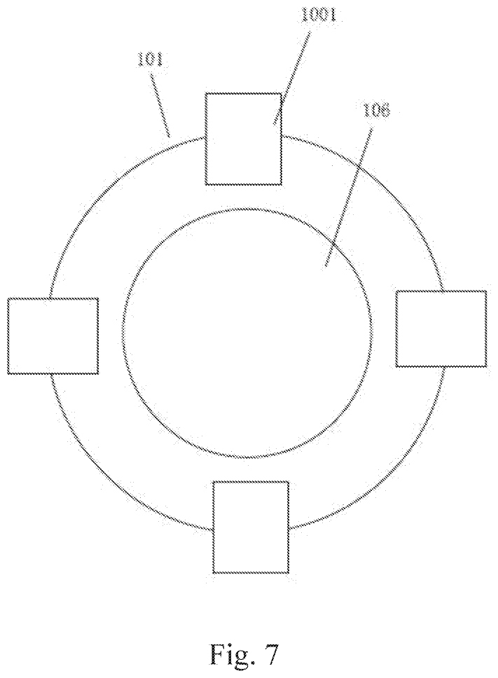

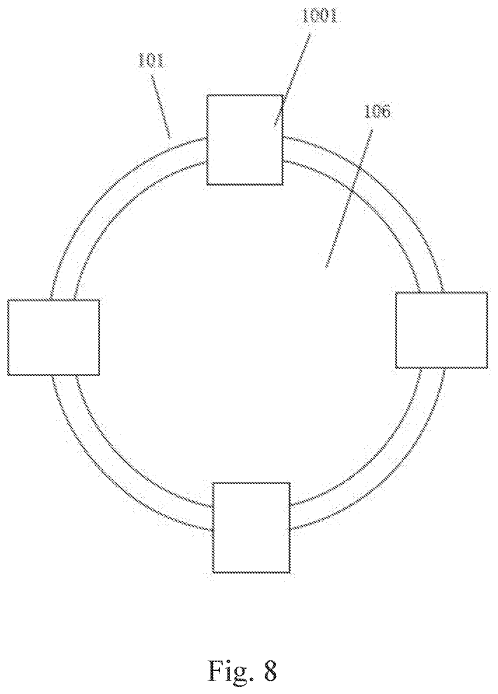

In the drawings, 101: turntable body; 102: base; 103: guide plate; 104: first guide rail; 105: second guide rail; 106: opening structure; 107: rotary sleeve; 108: wheel; 109: worm; 1001: forming mold; 1002: first roller; 1003: second roller; 1004: wrapper receiving plate; 1005: mold cup.

### DETAILED DESCRIPTION OF THE PREFERRED EMBODIMENT

### First Embodiment

A turntable assembly of a filling-wrapping food forming machine comprises a turntable body 101, multiple forming molds 1001 evenly distributed on the turntable body 101, and an opening structure 106 provided on the turntable body 101 for wrapper scrap access to achieve the recovery of wrapper scraps, wherein a distance from an inner side of each of the multiple forming molds 1001 to a center of the turntable body 101 is larger than a distance from an inner side of the opening structure 106 to the center of the turntable body 101. Here, the opening structure 106 is a through-hole structure which penetrates through the turntable body 101. When the distance from the inner side of each of the multiple forming molds 1001 to the center of the turntable body 101 is larger than the distance from the inner side of the opening structure 106 to the center of the turntable body 101, wrapper scraps will more easily fall into the opening structure 106 for recycling. A motor drives the turntable body 101 to rotate, so as to drive the multiple forming molds 1001 connected with the turntable body 101 to rotate together, the wrapper scraps after the peeling treatment enter the opening structure 106 on the turntable body 101, thereby achieving the recovery of wrapper scraps. A base 102 and a guide plate 103, both of which are located below the turntable body 101, maintain independence from the turntable body 101, so that the base 102 and the guide plate 103 stay still in the course of work. Moreover, guide rails are respectively provided on both the base 102 and the guide plate 103, wrapper receiving plates 1004 and the forming molds 1001 are driven to move up and down via rollers of the forming molds 1001 under the action of the guide rails. Through the opening structure 106 of the turntable assembly for wrapper scrap access after the peeling treatment, the present invention is able to achieve the recovery of wrapper scraps on the basis of the existing structure and make full use of the space under the turntable assembly. A recycling bin is placed or a wrapper scrap processing apparatus is installed under the opening structure 106, so that the wrapper scraps are directly stored or reused after being treated. In addition, the above structure does not increase the occupied space of the overall machine, and solves the problem that the overall machine is unable to be further miniaturized since extra space is required for the treatment of wrapper scraps.

### Second Embodiment

A turntable assembly of a filling-wrapping food forming machine comprises a turntable body 101, multiple forming molds 1001 evenly distributed on the turntable body 101, and an opening structure 106 provided on the turntable body 101 for wrapper scrap access to achieve the recovery of wrapper scraps, wherein a distance from an inner side of each of the multiple forming molds 1001 to a center of the turntable body 101 is larger than a distance from an inner side of the opening structure 106 to the center of the turntable body 101. Here, the opening structure 106 is a through-hole structure which penetrates through the turntable body 101. When the distance from the inner side of each of the multiple forming molds 1001 to the center of the turntable body 101 is larger than the distance from the inner side of the opening structure 106 to the center of the turntable body 101, the wrapper scraps will more easily fall into the opening structure 106 for recycling.

The opening structure 106 is continuously set on the turntable body 101. The continuous setting means that the opening structure 106 is not disconnected, and is a complete whole. Therefore, under the premise that the turntable body 101 rotates, the continuous wrapper scraps are able to continuously fall into the opening structure 106. Only when the opening structure 106 is continuously set, the wrapper scraps are able to be recovered during the rotation of the turntable assembly.

The opening structure 106 is round, which is able to be provided in a middle of the turntable body 101. Alternatively, the opening structure 106 is annular, which is able to be provided in the middle of the turntable body 101 or provided at a position outside the middle of the turntable body 101.

The opening structure 106 penetrates through an upper surface and a lower surface of the turntable body 101.

The relative position of the forming molds 1001 to the opening structure 106 is described as follows.

An upper surface of each of the forming molds 1001 is provided above an upper surface of the opening structure 106, and each of the forming molds 1001 is located outside the opening structure 106. Alternatively, the upper surface of each of the forming molds 1001 is provided above the upper surface of the opening structure 106, and the projection of each of the forming molds 1001 in the vertical direction partially or completely falls within the opening structure 106.

Limitation on the shape of the turntable body 101 is described as follows.

The turntable body 101 is rectangular, circular or irregular.

A rotary sleeve 107 is located below the turntable body 101 and is connected with a wheel 108, the wheel 108 is connected with a worm 109, the worm 109 is connected with the motor.

The motor drives the turntable body 101 to rotate, so as to drive the forming molds 1001 which are connected with the turntable body 101 to rotate together, the wrapper scraps after the peeling treatment enter the opening structure 106 on the turntable body 101, thereby achieving the recovery of wrapper scraps. A base 102 and a guide plate 103, both of which are located below the turntable body 101, maintain independence from the turntable body 101, so that the base 102 and the guide plate 103 stay still in the course of work. Moreover, guide rails are respectively provided on both the base 102 and the guide plate 103, wrapper receiving plates 1004 and the forming molds 1001 are driven to move up and down via rollers of the forming molds 1001 under the action of the guide rails.

Through the opening structure 106 of the turntable assembly for wrapper scrap access after the peeling treatment, the present invention is able to achieve the recovery of wrapper scraps on the basis of the existing structure and make full use of the space under the turntable assembly. A recycling bin is placed or a wrapper scrap processing apparatus is installed under the opening structure 106, so that the wrapper scraps are directly stored or reused after being treated. In addition, the above structure does not increase the occupied space of the overall machine, and solves the problem that the overall machine is unable to be further miniaturized since extra space is required for the treatment of wrapper scraps.

The opening structure 106 of the present application has various shapes according to actual needs, as long as under the premise that the wrapper scraps are convenient to fall into the opening structure 106. Under the premise that the distance from the inner side of each of the forming molds 1001 to the center of the turntable body 101 is larger than the distance from the inner side of the opening structure 106 to the center of the turntable body, whether each of the forming molds 1001 is located outside the opening structure 106, or the projection of each of the forming molds 1001 in the vertical direction partially or completely falls within the opening structure 106, it is ensured that the wrapper scraps are able to easily enter the opening structure 106 without installing additional wrapper scrap guiding device.

The present invention adopts the motor to drive a transmission structure formed by the wheel 108 and the worm 109, so as to drive the rotary sleeve 107 and the turntable body 101 to rotate, the independent driving structure ensures that there is no need to set a complicated cam transmission structure below the turntable body 101 as in the prior art, avoiding the problem of a power source driving all components, so that a lot of space are saved for the storage or follow-up treatment of wrapper scraps.

### Third Embodiment

Based on the first embodiment and the second embodiment, a base 102 is located below the turntable body 101, a guide plate 103 located between the base 102 and the turntable body 101 has a cylindrical shape as a whole; a first guide rail 104, provided at an outer side of the cylindrical guide plate 103, respectively cooperates with first rollers 1002 through wrapper receiving plates 1004 of the forming molds 1001, so as to realize the lifting movement of the wrapper receiving plates 1004 at different levels.

The guide plate 103 is a continuous cylinder. Alternatively, the cylindrical guide plate 103 has a disconnection portion, and the disconnection portion is partially disconnected or completely disconnected, which means that the guide plate 103 is provided only at a position where the components on the forming molds 1001 need to be adjusted up and down, and the guide plate 103 is omitted at a position that does not need to change the height. There is at least one disconnection portion.

A second guide rail 105, provided at an outer edge of the base 102, respectively cooperates with second rollers 1003 through mold cups 1005 of the forming molds 1001, so as to realize the lifting movement of the mold cups 1005 at different levels.

Specifically, the structure of the forming molds 1001 is the prior art. Each of the forming molds 1001 comprises a wrapper receiving plate 1004 and a mold cup 1005 located within the wrapper receiving plate 1004. The first rollers 1002 are respectively connected with a bottom of the wrapper receiving plates 1004 through a connecting rod. The second rollers 1003 are respectively connected with a bottom of the mold cups 1005 through another connecting rod. Since the forming molds 1001 rotate with the turntable body 101, and the guide plate 103 and the base 102 remain stationary, the wrapper receiving plates 1004, respectively driven by the first rollers 1002, move up and down along the wavy path of the first guide rail 104 which is provided at the outer side of the guide plate 103. The mold cups 1005 also move up and down at different levels with the cooperation of the second guide rail 105 and the second rollers 1003. As a result, the lifting action of the forming molds 1001 at different stations and different parts is realized.

The guide plate 103 and the base 102 cooperate with each other to respectively control the lifting movement of the wrapper receiving plates 1004 and the mold cups 1005 on the forming molds 1001 at different positions. Both the first guide rail 104 on the guide plate 103 and the second guide rail 105 on the base 102 are able to be set as a discontinuous structure, that is, the first guide rail 104 and the second guide rail 105 are set only at a station where the corresponding structural height needs to be adjusted, there is no need to continuously set the rails, which saves materials and simplifies the structure.

1-14. (canceled)

15: A turntable assembly of a filling-wrapping food forming machine, which comprises: a turntable body, multiple forming molds evenly distributed on the turntable body, and an opening structure provided on the turntable body for wrapper scraps access to achieve wrapper scraps recovery, wherein a distance from an inner side of each of the multiple forming molds to a center of the turntable body is larger than a distance from an inner side of the opening structure to the center of the turntable body.

16: The turntable assembly of the filling-wrapping food forming machine, as recited in claim 15, wherein the opening structure is continuously set on the turntable body.

17: The turntable assembly of the filling-wrapping food forming machine, as recited in claim 16, wherein the opening structure is round.

18: The turntable assembly of the filling-wrapping food forming machine, as recited in claim 16, wherein the opening structure is annular.

19: The turntable assembly of the filling-wrapping food forming machine, as recited in claim 15, wherein the opening structure penetrates through an upper surface and a lower surface of the turntable body.

20: The turntable assembly of the filling-wrapping food forming machine, as recited in claim 15, wherein an upper surface of each of the forming molds is provided above an upper surface of the opening structure, and each of the forming molds is located outside the opening structure.

21: The turntable assembly of the filling-wrapping food forming machine, as recited in claim 15, wherein an upper surface of each of the forming molds is provided above an upper surface of the opening structure, and a projection of each of the forming molds in a vertical direction partially or completely falls within the opening structure.

22: The turntable assembly of the filling-wrapping food forming machine, as recited in claim 15, wherein the turntable body is rectangular, circular or irregular.

23: The turntable assembly of the filling-wrapping food forming machine, as recited in claim 15, wherein a rotary sleeve is located below the turntable body and is connected with a wheel, the wheel is connected with a worm, the worm is connected with a motor.

24: The turntable assembly of the filling-wrapping food forming machine, as recited in claim 23, wherein a base is located below the turntable body, a guide plate located between the base and the turntable body has a cylindrical shape as a whole; a first guide rail is provided at an outer side of the cylindrical guide plate.

25: The turntable assembly of the filling-wrapping food forming machine, as recited in claim 24, wherein the guide plate is a continuous cylinder.

26: The turntable assembly of the filling-wrapping food forming machine, as recited in claim 24, wherein the cylindrical guide plate has a disconnection portion, and the disconnection portion is partially disconnected or completely disconnected.

27: The turntable assembly of the filling-wrapping food forming machine, as recited in claim 26, wherein there is at least one disconnection portion.

28: The turntable assembly of the filling-wrapping food forming machine, as recited in claim 24, wherein a second guide rail is provided at an outer edge of the base.
